(19) United States
(12) Patent Application Publication
(10) Pub. No.: US 2005/0210000 A1
(43) Pub. Date: Sep. 22, 2005

(54) Semantic web portal graphic interface

(75) Inventor: Alain Michard, Triel Sur Seine (FR)

Correspondence Address: FOLEY AND LARDNER;SUITE 500, 3000 K STREET NW, WASHINGTON, DC, 20007, US

(73) Assignee: INRIA INSTITUT NATIONAL DE

(21) Appl. No.: 10/494,965

(22) PCT Filed: Nov. 5, 2002
(86) PCT No.: PCT/FR02/03783

§ 371 Date: May 7, 2004

(30) Foreign Application Priority Data
Nov. 13, 2001 (FR) 01/14661

(51) Int. Cl. G06F 7/00

(52) U.S. Cl. 707/3

(57) ABSTRACT

The invention concerns a computer system for generating a web portal graphic interface, comprising a request manager (GR), designed to co-operate with a history manager (GH) and a graphic generator (GG) to display entities based on data stored in a database. The request manager (GR) reacts to the fact that an entity is pointed at by the user, by executing on the database an internal quest, defined from a selected quest expression, depending on the type entity, and completed in accordance with the entity. This provides novel data, on the basis of which, the display is modified. The history manager (GH) interacts step by step with said request manager (GR), to construct a user request based on successive selections concerning the entities pointed at by the user on the graphic interface. The graphic generator (GG) then displays an adapted representation of the results produced by the request manager, in accordance with a predetermined format.

The invention relates to the interrogation of a database.

The interrogation can take place through a “portal”, which is in the form of a graphical interface in relationship with a database, the data of which are accessible via a query language. A portal on the web is accessible on a public or private web server and offers its users various possibilities of search and exploration in an information space composed of collections of resources (a term in particular defined by the working party developing the new standards for the Internet, the IETF, “Internet Engineering Task Force”). The resources are entities containing data, such as, for example, a directory, a digital document or a set of data extracted from a database, which have a unique URI (“Universal Resource Identifier”) and to which it is possible to gain access by means of a communication protocol.

A distributed information system of the web type therefore offers access to resources with various formats. The resources are organised in hierarchies of directories situated on servers, the number and location of which vary widely according to circumstances. Client applications of these servers enable users to explore the content of the directories and to display the data. Client servers and applications communicate by means of protocols, the most usual of which are HTTP (“HyperText Transfer Protocol”) and the file transport protocol FTP. A web may be public, that is to say the so-called “World Wide Web” or private, as is a so-called “Intranet” business network.

The expression “semantic web” is sometimes used. This expression designates a web whose resources are described by a set of variables known as “descriptors” or “metadata”. These descriptors are used by programs which assist the users to seek information or to filter the information available on the web, according to criteria peculiar to these users. All the descriptors authorised in a given semantic web form a conceptual schema. A conceptual schema can be “object oriented”, in which case each resource is considered to be an instance of one class (at least), and relationships are defined between this class and the other classes of the conceptual schema. Every resource can then be described by means of the literal attributes peculiar to its class, and properties taking objects which are instances of other classes as values.

In the known data or resource search devices, the web portals use only relational conceptual schemas, describing databases structured in tables. These devices propose one of the following three methods or a combination of these:
the exploration of a hierarchical resource directory, in the form of a set of linked resources, the first of which presents the titles of the root categories, and the others gradually present the child categories of the one previously selected by the user (transitive hyponymy relationship),
the search for resources according to the occurrence in these of one or more textual lexical units,
the evaluation of a query chosen by the user from amongst predefined queries, the evaluation being carried out by interrogating the database according to the designated query.

None of these methods enables the user to search for resources by specifying research criteria freely chosen amongst all the possible research criteria in the database. The user is therefore confronted with limitations in his possibilities of information search. This is because the first method allows only the exploration of the hierarchy of the categories without its being possible to search for the resources, by criteria other than their belonging to these predefined categories. The second method results in a high level of noise because of the polysemy of the natural language terms. The third method reduces the search possibilities to the queries predefined by the programmer, and makes the latter have to carry out specific programming for each query which he wishes to make available to the user.

The present invention improves the situation.

It proposes for this purpose a data processing system comprising a query manager intended to work with a history manager and a graphics generator for displaying entities according to data stored in a database. Advantageously, the query manager is capable of reacting to the fact that a displayed entity is “pointed to” by the user, executing on the database an internal query, defined from a chosen query expression, according to the type of entity, and supplemented according to the entity. This supplies new data, from which the display is modified. The history manager is arranged so as to interact step by step with the query manager in order to construct a user query from successive selections relating to the entities pointed to by the user on the graphical interface. The graphics generator is capable of displaying an adapted representation of the results produced by the query manager, according to a predetermined formatting.

According to another aspect of the invention, the query manager is arranged so as to interrogate in the same way the class graphs describing the database and the class graphs describing the data.

Advantageously, the history manager is able to successively combine the elementary queries constructed from elements stored, according to a logic operator, in order to calculate the user query.

The present invention also proposes a method for generating a web portal graphical interface, intended to interrogate a database,

characterised in that it comprises the following steps:

a. presenting to the user a starting display derived from stored data, the entities displayed being of the class or object type,
b. in response to the pointing by the user to an entity, executing an internal query on the database, defined from a chosen query expression, according to the type of entity, and supplemented according to the entity,
c. modifying the display from the data supplied by step b,
d. repeating steps b and c until there is a decision from the user.

Finally, the invention also considers a program product, which can be defined as comprising the functions for executing steps a to d of the above method, and/or as comprising the functions of the system defined above.

Other characteristics and advantages of the invention will emerge from an examination of the following detailed description and accompanying drawings, in which:

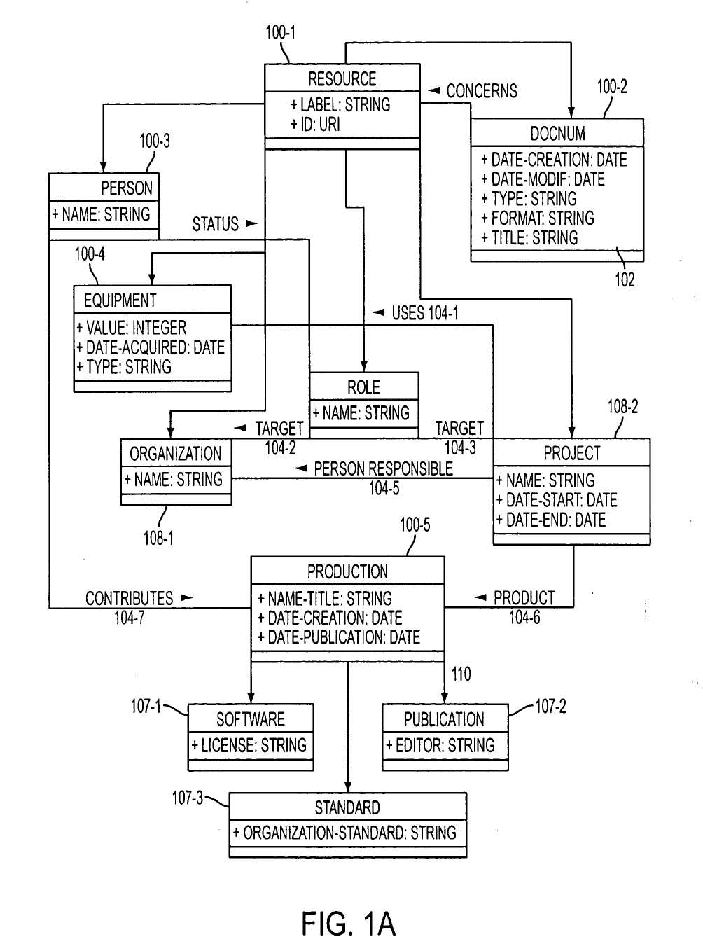

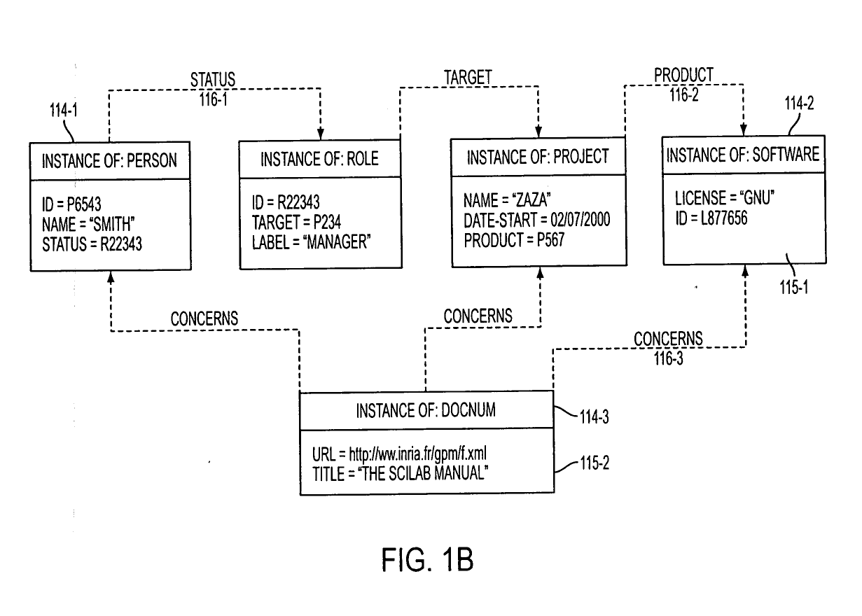

FIG. 1a shows an example of class graphs extracted from an object oriented conceptual schema;

FIG. 1b shows instances of classes of the class graph of FIG. 1a;

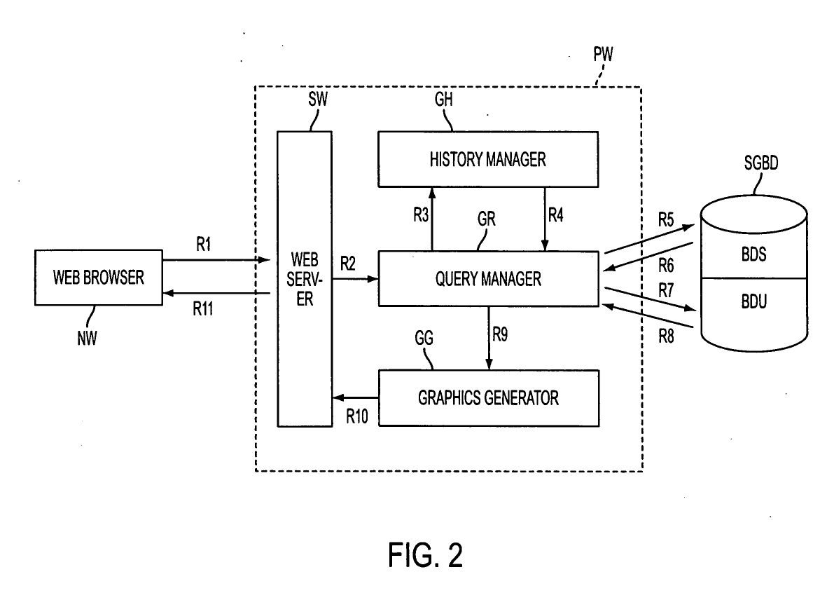

FIG. 2 is a block diagram illustrating the web portal, the database management system, the web navigator, and their interactions;

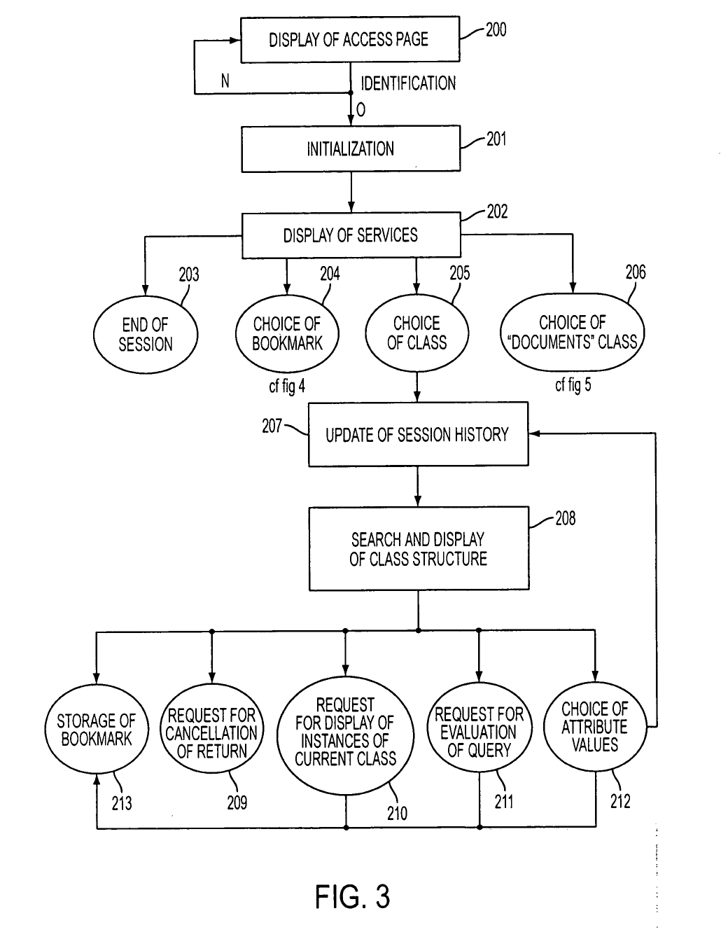

FIG. 3 is a flow diagram of the operations used for implementing the present invention;

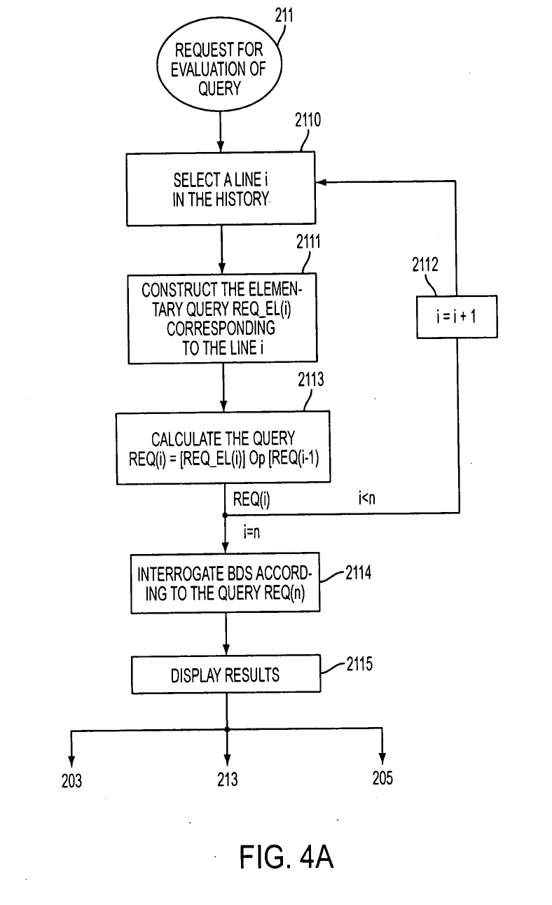

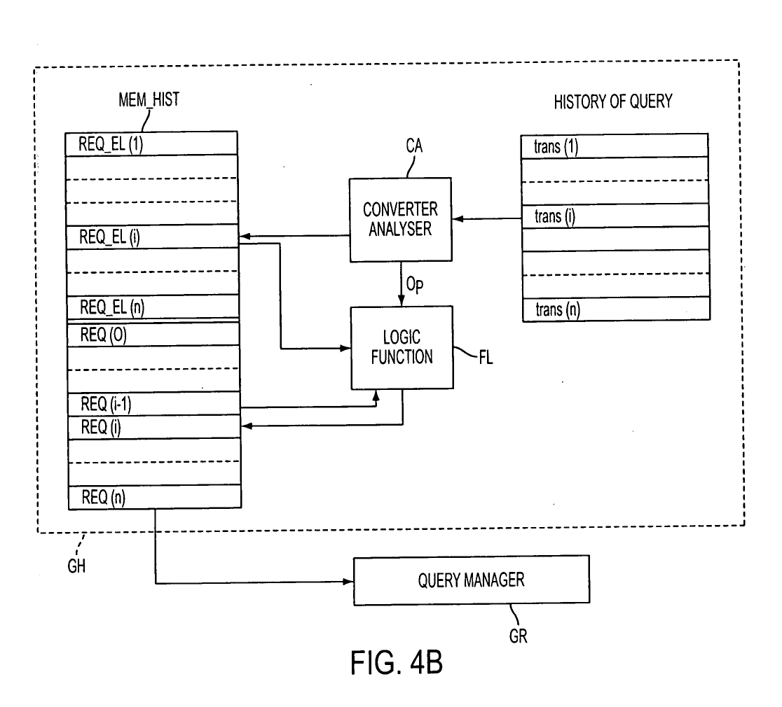

FIG. 4a is a flow diagram of the operations taking place in the evaluation of a user query;

FIG. 4b is a block diagram illustrating the evaluation of a user query;

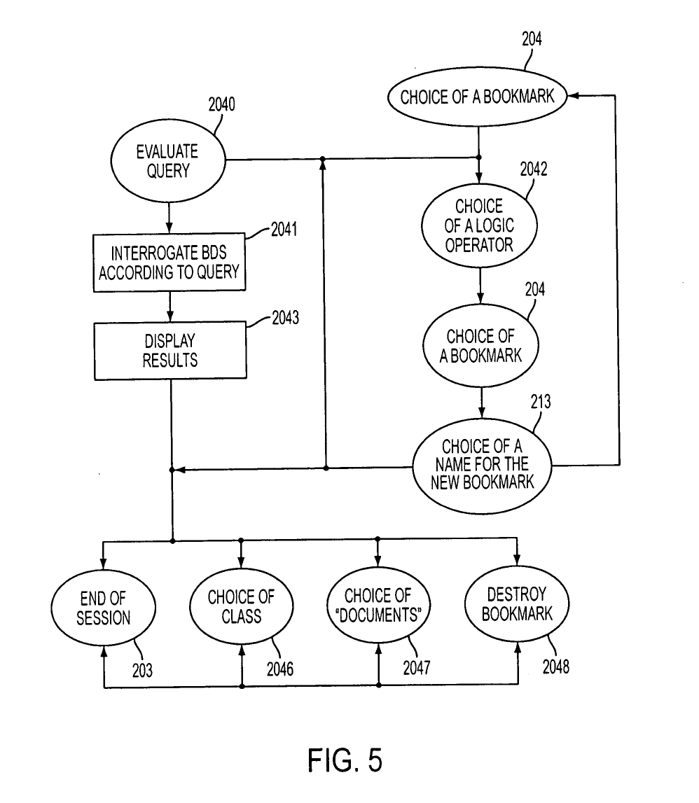

FIG. 5 is a flow diagram of the operations used for implementing the management of the bookmarks;

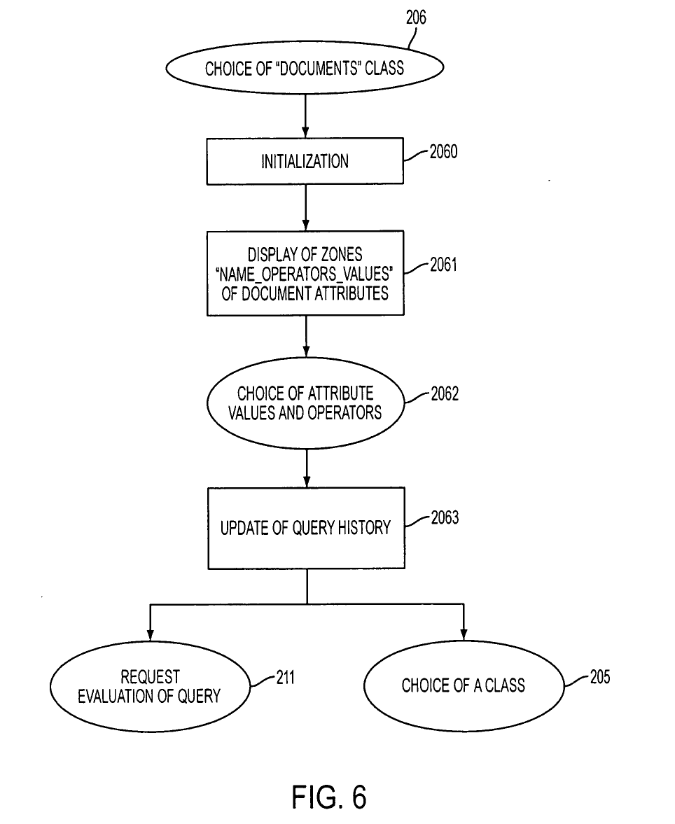

FIG. 6 is a flow diagram of the operations allowing selection by document management attributes;

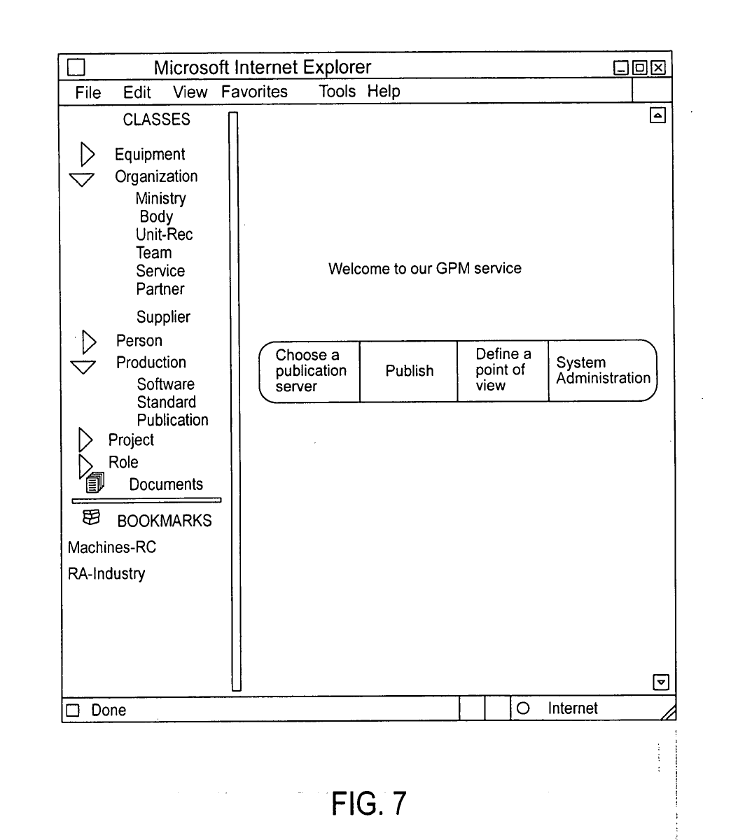

FIG. 7 is an example of a graphical interface, when a tree of the classes of a conceptual schema is displayed;

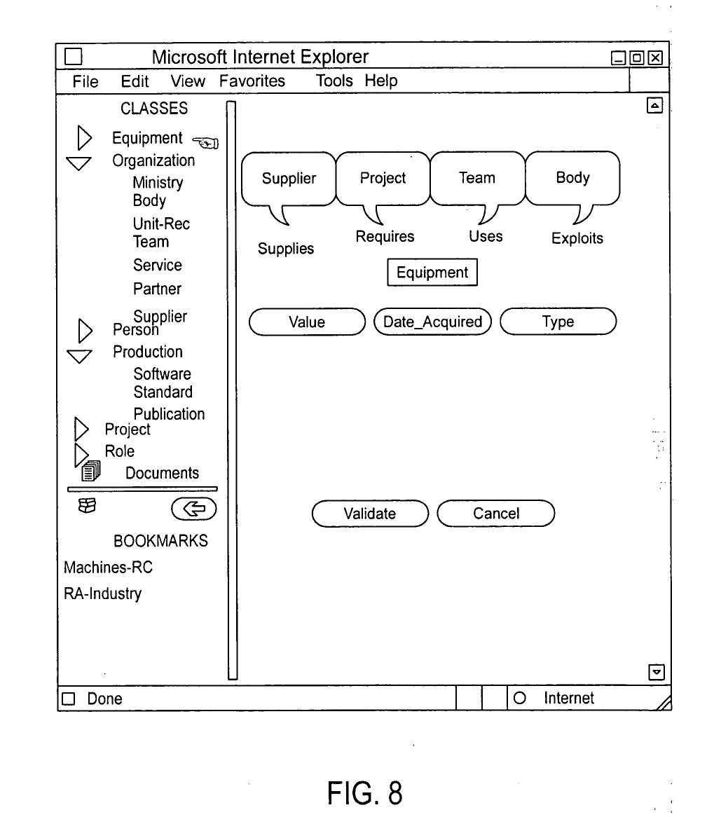

FIG. 8 illustrates the display of the structure of a class;

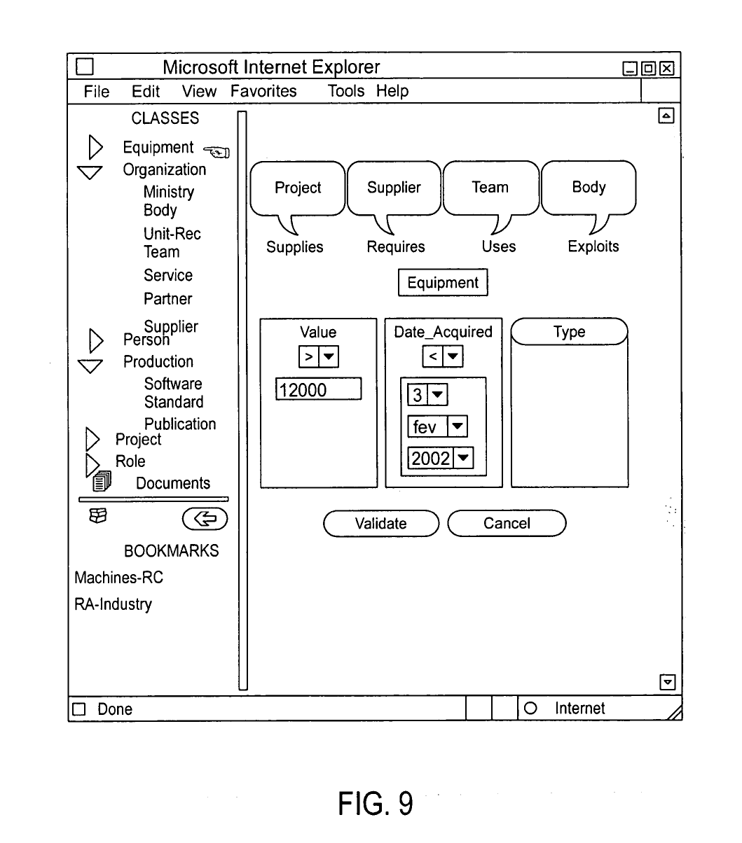

FIG. 9 is an example of a graphical interface, showing the restriction of an elementary query to attribute values;

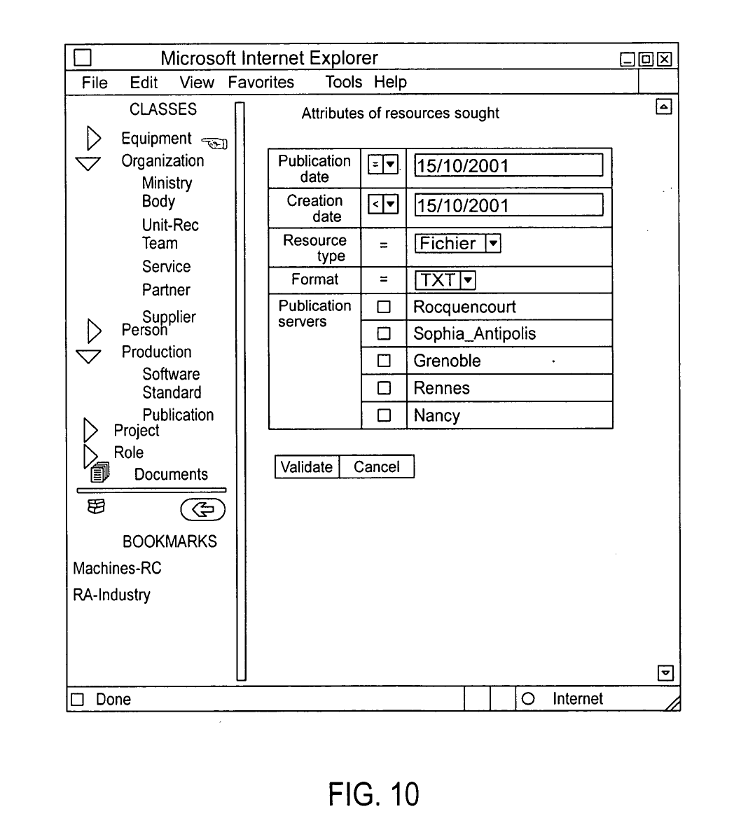

FIG. 10 illustrates the restriction of the user query to values of attributes of document resources;

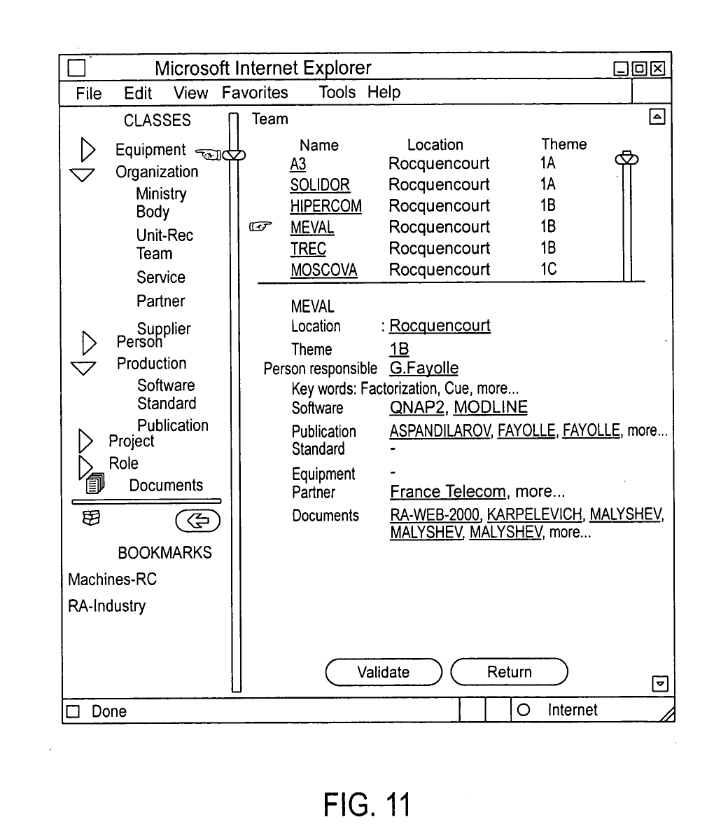

FIG. 11 shows the display of a list of objects resulting from the evaluation of a user query and of an object which is an instance of a class, chosen from this list;

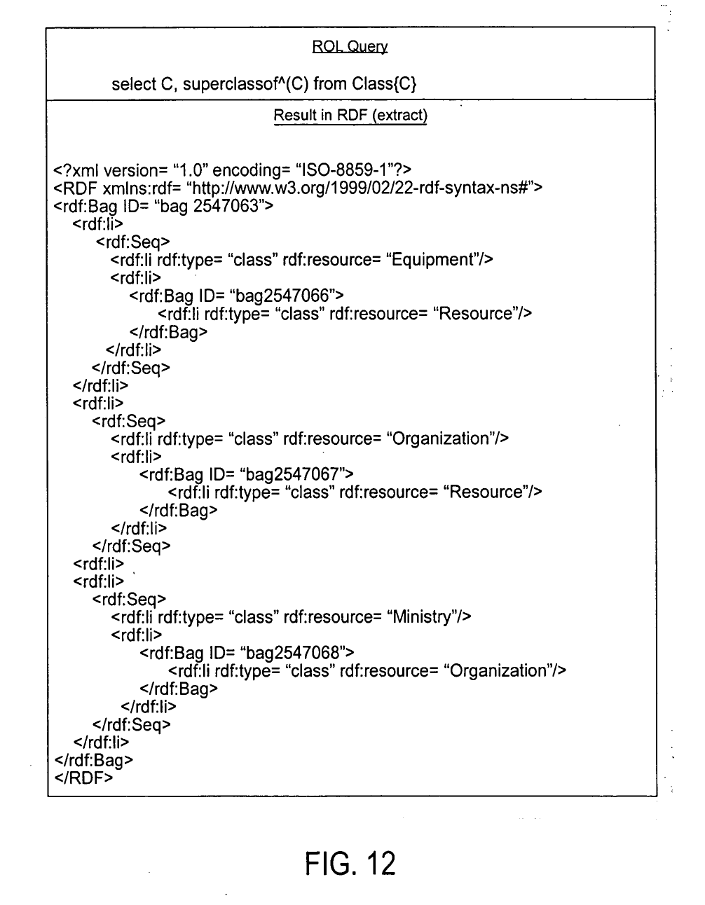

FIG. 12 shows, in RDF formalism, a hierarchy of classes and properties which link them; and

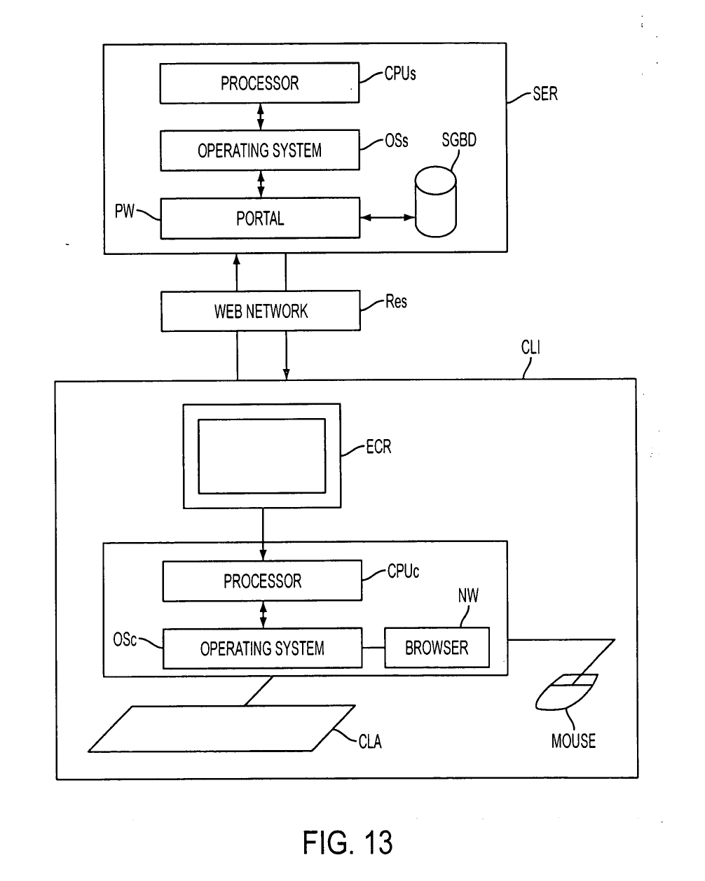

FIG. 13 is an example of a platform for implementing the present invention.

The present document can contain elements open to protection by copyright. The holder of the rights does not object to the identical reproduction by anyone of this patent document, as it appears in the files and/or publications of the patent offices. On the other hand, it reserves for the rest all its copyright.

The drawings contain essentially elements of a certain character. They can therefore not only serve to give a better understanding of the description but also contribute to the specification of the invention, where appropriate.

The following detailed description will be given principally with reference to the case of document management, by way of non-limiting example. A semantic web portal can in fact be used as a document management tool making it possible to make a document search on a database.

FIG. 1a shows a class graph extracted from a conceptual schema. The expression “class graph” is used here for clarity, it being noted that the corresponding representation in data processing may take various forms, in general non-graphical. In such a modelling, a class 100 (100-1 to 100-5) can be qualified by attributes typed 102. It may be linked to sub-classes 107 (107-1 to 107-3) by the “sub-class” relationship 110. A child class 107 inherits the attributes of its parent class 100. A class 108 (108-1 to 108-2) can be linked to the class 100 by a labelled relationship 104 (104-1 to 104-7), for example uses or exploits. According to circumstances, the relationship 104 can be transitive or not. A class graph makes it possible to define objects which are instances of classes such as the objects 114 (114-1 to 114-3) in FIG. 1b, linked to their class by the instantiation relationship. Such an object is described by means of attributes 115 (115-1 to 115-2) and properties 116 (116-1 to 116-3).

The document resources themselves can be represented as instances of a “documents” class or its sub-classes. These resources will consequently be described by means of attributes and relationships defined, in the schema, for this class of document and for any sub-classes thereof. In the version described, the present invention can be implemented only if the conceptual schema used complies with the following restriction: a relationship can have only one original class D and a single target class R, the relationship however being defined for all the sub-classes of D and R.

In a particular embodiment, such a conceptual schema model, and the descriptions of objects and resources which it enables, are expressed in the description model of the RDF (“Resource Description Framework”) resources, defined by the international consortium W3C, and can be stored in a database.

The present invention makes it possible to store a database constructed according to such a class graph, exhaustively, in order to find the objects and resources with the properties specified by the user.

FIG. 2 shows the various functional blocks used for implementing the present invention. The portal PW comprises a web server (SW), a query manager (GR), a history manager (GH) and a graphics generator (GG), all communicating with a web browser NW and with a database management system SGBD. Communication between the portal PW and the browser NW uses the HTTP protocol. Communication between the portal PW and the SGBD uses the query language LR.

In a particular embodiment, LR is the relational query language RQL (“Relational Query Language”) defined by the research institute Forth, and relational database management system PostgreSQL developed and distributed in free software, provided with an extension allowing interpretation of the queries formulated in this language. As a variant, it is possible to use another database management system, of the relational-object or purely object type, and another query language LR, such as the structured query language SQL-3 (“Structured Query Language”) or the object database interrogation language OQL (“Object Query Language”) proposed by the ODMG.

In the example, the database management system SGBD manages two databases, BDS and BDU, whose respective roles are described below. In a variant it is possible to use two distinct SGBDs. This SGBD or SGBDs may be accessible either directly or through a suitable interface, by means of one of the query languages LR cited above.

The database BDS contains:
the description of the classes of the conceptual schema with, for each class, the list of its attributes, and the type of its attributes;
the description of the relationships defined between the classes of the schema. For each relationship there are given the identifier of an original class, the identifier of a target class and a label naming the relationship;
the tables describing the objects which are instances of the classes, with the values of their attributes and the identifiers of the target objects;
the tables describing the document resources by means of specific attributes defined in the conceptual schema, and properties taking objects which are instances of classes as their values.

The structure of the base BDS makes it possible, using the language LR, to find the information which makes up the conceptual schema, as well as the description of the objects which are instances of the schema.

The database BDU contains information relating to the user of the portal, in particular the bookmark queries which it has recorded during previous sessions, the queries to which it is a subscriber, as well as its rights of access to subsets of the information system.

Each user interacts with the device by means of a web browser NW. It is a case of a widely distributed software such as Internet Explorer from Microsoft, or Navigator from Netscape. The browser NW is capable firstly of creating a graphical and textual representation of a resource described in a standard language such as HTML (HyperText Markup Language) or XML (eXtensible Markup Language), and secondly of issuing queries in accordance with the HTTP protocol. The designation by the user of a particular graphical entity causes the sending by NW of a particular HTTP query R1. In a particular embodiment, NW is provided with an extension which enables it to interpret the SVG graphical language (“Scalable Vector Graphics”, an extension distributed by the company Adobe).

The invention can be implemented on a server machine SER of the type given purely by way of example in FIG. 13, which comprises at least one operating system OSs which supports the portal PW and the database servers SGBD, as well as a processor CPUs. The server machine SER communicates with the client machines CLI of the users, which are personal computers PC, connected to a local or public network RES, supporting the web to which the device gives access. Each client machine comprises a processor CPUc, an operating system OSc and a browser NW, as well as peripherals such as a display screen ECR, a keyboard CL and a pointing peripheral known as a “mouse” SOU.

The browser NW interacts with the server SW through the network. The web server SW receives each query HTTP issued by a browser NW, and, according to the content of this query, activates the appropriate procedure of the query manager GR. When the query HTTP received is of the POST type, the server SW passes to the query manager GR the parameters contained in the query POST. In the reverse direction RIO, the server SW receives the HTML or XML resources generated by the graphics generator GG, and transmits them (R11) to the appropriate browser NW. The server SW is also responsible for creating and managing interactive sessions for each user, guaranteeing that each HTTP query received from a browser NW is indeed allocated to a string peculiar to an identified user.

The query manager GR provides the logic processing of the queries. It receives the entities pointed to by the user and generates an internal query in order to interrogate the database on the structure of these entities. It moreover interrogates the database according to the user query which was transmitted to it by the history manager GH, a query which corresponds to the search required by the user. It then transmits the results obtained to the graphics generator GG, which displays a corresponding representation.

The query manager also manages all the interactions with the user, as well as the exchanges with the SGBD.

Using the parameters R2 which SW transmits to it, and those R4 which it obtains from the history manager GH, it forms one or more queries in the language LR and sends this query R5 to the SGBD. The SGBD returns the data corresponding to this query R6. In one embodiment, these data are coded in the XML formalism RDF. However, it would be possible to use another XML formalism preserving the structure of the results returned by the SGBD.

The graphics generator GG is activated by the query manager GR by means of the communication R9, each time it obtains data from the SGBD in response to a query. The graphics generator GG transforms these data into an XML or HTML representation which can be transmitted to the server SW (R10) and then to the browser NW (R11) in order to be interpreted and displayed graphically there. In a particular embodiment, the graphics generator GG is an XSLT interpreter which receives as an input the XML tree produced by the request manager GR and a predefined XSLT style sheet. The processor GG transforms the XML tree into an HTML or SVG (“Scalable Vector Graphics”) resource, which is then transmitted to the server SW.

The history manager GH manages the history of the elementary queries produced by a user during an interactive session. Receiving messages R3 from the query manager GR, it updates, for each user, a data structure representing the history of the queries issued by him during the interactive session. The messages R3 relate to the structure of the entities designated by the user, obtained from an interrogation of the database by the query manager GR. The said data structure enables the history manager to calculate a query from a logic combination of elementary requests corresponding to the various elements of the data structure. The history manager GH then returns the calculated user query R4 to the request manager GR, which can then submit it to the SGBD for an evaluation (R5).

In a particular embodiment, the query manager GR, the history manager GH and the graphics generator GG are written in Java language, and the communication with the SGBD uses an interface according to the JDBC (“Java DataBase Connectivity”) industrial standard, defined by Sun Microsystems.

FIGS. 3 to 6 show an example of functioning of the web portal system. In these figures, the rectangles with rounded corners represent actions by the user, and the rectangles with straight corners show the processings carried out by the device in response to these actions.

Reference is made to FIG. 3, which describes the overall functioning of the portal. At step 200, a user accesses the web portal. This step may comprise interactive operations allowing the identification of the user by any suitable means. For example, it is possible to request the user to identify himself by entering his user name and password. These identification operations are described in known embodiments. Subsequently it will be assumed that the system has been able to identify the user.

The user is therefore authorised to access at the initialisation step 201. During this step, the system initialises an interactive session for the user. An interactive session commences when a user connects and is identified, and ends when the user so requests or when the duration fixed for the session has elapsed. The system also creates a session history whose role will be detailed at step 207. The system then searches in the database BDU for the bookmarks defined for the user, and then searches in the database BDS the hierarchy of classes defined in the conceptual schema. By way of example, in a particular embodiment, the search in the database BDS is carried out by virtue of the following RQL query:
select C, superclassof\hat{ }(C) from Class{C}

This query may give as a result an RDF resource of the form shown in FIG. 12. It can be seen that this result describes each class, in the RDF formalism, indicating what is its superclass in the conceptual schema used. The above query aims to construct pairs each formed by a class identifier and the identifier of its superclass. In the example in FIG. 12, all the results are supplied in the form of a non-ordered set (the element bag). Each pair is given in an element li in the form of a sequence seq. The first pair is formed by the class identifier “Equipment”, and then the root class identifier “Resource” predefined in the RDF model. This first pair therefore indicates that there exists in the conceptual schema interrogated a class “Equipment” at the highest level defined in the schema. The following pair indicates that there exists a class “Organisation”, also at the highest level in the conceptual schema. Finally, the last pair indicates that there exists a class “Ministry” whose superclass is the organisation class.

Using this XML resource, the graphics generator GG can then generate a service presentation page (202). FIG. 7 shows an example of presentation of the classes in the left-hand box of the browser. The content of the right-hand main box depends on each database BDS. The bookmarks appearing in the bottom part of the left-hand box are described below at step 204. The list of classes appearing in the left-hand box is generated by the graphics generator GG from the RDF resource of which FIG. 12 is an extract, and an XSLT style sheet. In a particular embodiment, and for reasons of optimisation, this HTML resource presenting the hierarchy of the classes can be generated at the time of the first query, and then placed in cache memory. It will be regenerated only in the event of modification of the schema. This optimisation, if it takes place, is effected by the standard functions of the web server used, independently of the query manager and graphics generator.

From step 202, the user has a choice between the following actions:
ending the session (step 203),
selecting a bookmark recorded (step 204),
selecting the class of documents (step 206), or
selecting one of the classes of the hierarchy of classes defined in the conceptual schema (step 205).

At step 205, the user selects by pointing to one of the classes presented on the screen, this presentation being able to result from step 202 or step 208.

At step 207, the history manager GH updates the query history peculiar to the session and to the user. This history makes it possible to determine at any time what is the query resulting from the Boolean combination “AND” of the set of choices made by the user during the interactive session. One possibility consists of representing this history as a dictionary of lists where the key is a transaction identifier in the current session, a new transaction being created whenever the user selects a new class and where each item is a list:
the first element of this list is the identifier of the class selected;
the second element may be:
   the identifier (URI) of the property defined in the conceptual schema between the current class selected and the class selected in the previous transaction, the direction of this property, that is to say the fact that one or other of these two classes is the origin or target of the relationship, not being taken into account;
   a nil value (represented in the present document by the symbol Nil), if the current class was selected in the hierarchy presented in the left-hand box of the display window, in one of the following cases:
      1) the current class is the first selected during the interactive session,
      2) the user has chosen a class which does not have any relationship with the class previously selected,
      3) the user has not wished to take account of such a relationship;
the following elements are triplets {name, operator, value} which describe the constraints of the attribute values defined by the user for the class selected. It should be noted that these triplets are created only when the updating of the history results from step 211. When the updating of the history results from a class selection made at step 212, without the user yet having specified attribute values, the entry created in the dictionary does not include triplets.

At step 208, the query manager searches in the database BDS for the list of attributes and properties of the class selected and of its superclasses, the type of these attributes, and the classes defining the value ranges of the properties of which the class selected is the origin. In a particular embodiment, this information can be obtained by the following RQL request:
select * from {Equipment}@P{:$$Y} where $$Y in Literal OR $$Y in Class
   where “Equipment” is assumed to be the identifier of the class selected.

The result of this query can then be transmitted to the graphics generator GG, which produces an HTML or SVG representation of the structure of the class. FIG. 8 shows an example of a graphical presentation thus generated, after the user has selected the “Equipment” class at step 205. The buttons “Value”, “Date_acquired” and “Type” indicate to the user that the instances of the class “Equipment” have attributes of this name for which he can, if he so wishes, choose a value in order to restrict further the selection of these instances. The buttons “Supplier”, “Project”, “Team” and “Organisation” indicate to the user that these classes have a property which links them to the class “Equipment”. The user can select these classes by means of these buttons, in order to restrict the current selection, as described at step 205. At the end of step 208, the user has the choice between the following options:
selecting one of the classes which is presented to him (step 205), namely a class linked to the current class by property. The choice of this option will result in a change of current class;
selecting a class in the hierarchy of classes presented in the left-hand box of the display window. A description is given at step 211 of how such a class selection has a different semantic from the class selection referred to in the previous paragraph;
cancelling the selection which has just been made (step 209);
specifying constraints on the values of the attributes of the current class in order to restrict the selection of objects to those satisfying these constraints (step 212);
requesting the display of objects which are instances of the previously selected class (step 210);
requesting the display of the list of document resources corresponding to the current selection (step 211).

At step 209, when the user activates the cancellation command, the history manager GH deletes from the session history the entry corresponding to the last selection made. The request manager GR next finds the previously selected class structure which happens to be that appearing in the last entry of the history thus updated. The graphics generator GG can consequently produce a display of the structure of this class exactly as was done during the previous step 205. In particular, it is possible to keep in RAM memory in the form of Java objects the representation of the structures of the classes previously explored by the user in order to avoid having to reinterrogate the database BDS when he cancels selections and thus goes back in his history of interactions with the device.

At step 212, the user decides to specify target values for the attributes of the objects which are instances of the current class which he wishes to select. FIG. 9 shows an example of a screen presented to a user during this step. The user can choose one of the operators >or <or =, if the attribute is numerical, or of the date type, and then a value. He can specify a value in the case of an attribute taking a string of characters as its value. When the user validates his choices of attribute values, the system passes to step 207 in order to update the query history whose structure was described above. During this updating, triplets {attribute name, operator, value} will be created in the entry corresponding to the current transaction for each of the attributes for which the user has specified a value.

At step 210, the user requests the display of the objects which are instances of the current class, possibly selected on the basis of the attribute values chosen during step 212. To meet this request, the query manager GR consults the history manager GH and obtains the n-tuplet representing the last transaction. This n-tuplet indicates the current class which was selected and, where applicable, the attributes of this class for which the user has indicated particular values. This n-tuplet makes it possible to form a query whose semantic is:
“Find the values of the attributes An, . . . Am, of all the objects Oj which are instances of C such as {A1, OP, Vi} AND {A2, OP, Vj}”
   where An . . . Am are attributes defined for the class C, C is the name of the current class, and {Ax, OP, Vi} represents a triplet {Attribute, Operator, Value} resulting from a choice by the user at step 212. When the current selection comprises several triplets, these are combined by the Boolean operator “AND” effecting the intersection of the subsets of objects selected by each of the triplets. The choice of the presentation attributes An . . . Am can vary for each embodiment of the device and for each class of object. This choice is controlled and determined by the system administrator, when the system is installed. In the examples in FIGS. 7 to 12, the objects have been represented by their symbolic name.

The query thus made in the query language LR is submitted to the SGBD managing the database BDS. The results returned are then transmitted to the graphics generator GG, which produces a presentation thereof in HTML with appropriate formatting.

The user can then point to one of the objects presented in this list and obtain a more complete description thereof, including all the attributes defined for this object. FIG. 11 illustrates a possible presentation of an object thus selected.

At step 211, the user requests the display of the list of document resources corresponding to the current selection. When the request manager GR receives the request to calculate the current selection of document resources, he activates the appropriate procedure of the history manager GH.

Reference is now made to FIG. 4a, which illustrates the various steps of the evaluation of a user query. In response to the query evaluation request 211, transmitted by the query manager, the history manager GH selects a line of the query history at step 2110, from which it calculates the corresponding elementary query, in the query language LR. It then temporarily stores this query in the variable REQ_EL(1). The history manager next initialises a variable REQ(1), allocating to it the value REQ_EL(1), at step 2113.

Following this initialisation phase, the history manager GH reiterates the following steps, for all the lines i in the query history, until all the lines of the history have been processed.

At step 2110, it selects a line i of the query history and constructs the corresponding elementary query REQ_EL(i), at step 2111. Each line i of the history contains the characteristics of a transaction i corresponding to the class Ci pointed to by the user. Following this selection, the history manager calculates a query REQ(i), by combination according to a logic operation op determined at step 2111 of the elementary query REQ_EL(i) and the previous query REQ(i). When all the lines of the history have been processed, REQ(n) contains in fact the user query corresponding to the document search which the user wishes. The history manager then passes to step 2113, where it transmits the last calculated query REQ(n) to the query manager GR.

Step 2111 comprises a prior step of analysing the items in the history, in order to determine the elementary query REQ_EL(i) which corresponds to each transaction i, as well as the logic operator op of step 2113. This analysis takes place according to the following principles:
when the class Ci is not linked to the previous one by a property identified in the history, in other words when the third item of the entry in the history has the value nil, the elementary query relating to this class corresponds to “the selection of all the digital documents having a defined relationship with the instances of the non-linked class Ci”. This class Ci will therefore be used at step 2113 in order to extend the selection of the digital documents, including those having a defined relationship with the instances of the non-linked class Ci. For this, the system generates a corresponding elementary query REQ_EL(i), which will be combined with REQ(i−1) by a logic operator op “OR”;
if the class Ci is that of the digital documents “Documents”, or one of its sub-classes (step 206), as indicated by the second item of the entry in the history, the elementary query relating to this class corresponds to “the selection of all the digital documents whose attributes comply with the value constraints indicated by the triplets of the history”. This class Ci will therefore be used at step 2113 in order to restrict the selection of the documents to those whose attributes comply with the value constraints indicated by the triplets of this transaction i. This restriction is made by generating a corresponding elementary request REQ_EL(i), which will be combined with REQ(i−1) by a logic operator op “AND”;
when the class Ci is linked to the previous one by a property identified in the history, or in other words when the third item of the entry in the history is different from nil, the elementary query relating to this class corresponds to “the selection of all the digital documents having a defined relationship with the instances of the linked class Ci”. This class Ci will therefore be used at step 2113 in order to restrict the selection of the digital documents having a defined relationship with the instances of class C1, the class C1 being the class selected during the first transaction of this concatenated list of transactions. This restriction is also made by generating a corresponding elementary query REQ_EL(i), which will be combined with REQ(i−1) by a logic operator op “AND”.

FIG. 4b represents the modules necessary for evaluating a query. The converter/analyser block CA converts the characteristics of the transaction i, trans(i) stored in the history into an elementary query REQ_EL(i) formulated in query language. This block also determines the logic operator op as a function of trans(i). The logic function block FL next calculates the new value REQ(i) from the inputs op, REQ_EL(i) and REQ(i−1) calculated at the previous step. At step n, the history manager sends REQ(n) to the query manager GR.

Consider now, by way of example, the following history, which comprises four transactions:
IT001 Equipment nil {Value>10,000}
IT002 Project Uses {Location=Rocquencourt}
IT003 Person nil {name=*Smith}
IT004 Documents nil {LastModified>01:01:2000}

The meaning of this history is as follows. The user, at the first step 205, has selected the class “Equipment”, then at step 212 has created a filter indicating a minimum value for the attribute “Value” of the instances of “Equipment”.

He has next chosen the class “Project”, linked to the class “Equipment” by the property Uses. For this class, he has indicated that he wishes to take into account only the Projects whose attribute Location has the value “Rocquencourt”. The user, by concatenating the selection of these two classes, has indicated that he wants documents concerning equipment with a price above 10,000, used by the projects located at Rocquencourt.

The user has next selected the class “Person” in the left-hand box of the display window. This class is not linked by an identified property to the previous class “Project”. Even if such a property existed in the conceptual schema, it would not be taken into account since it does not explicitly appear in the history, because the user has selected the class “Person” in the left-hand box of the display window.

Finally, the user has selected the class “Documents”, and has indicated that he wished to restrict the selection of documents to those modified after 1 Jan. 2000.

In this example, the current selection of document resources is the result of the query whose semantic, expressed in pseudo-natural language, is:
“Find all the resources D which are document instances”, such as expr1 AND [expr2 AND ((expr3 OR expr4) AND expr5)] OR expr6, where
expr1=“D has an attribute “LastModified” whose value is a date subsequent to 1 Jan. 2000”,
expr2=“D is linked to X by any relationship R1, X being an instance of the class “Equipment”, the attribute “Value” for X having a value greater than 10,000”,
expr3=“X is linked to Y by a relationship Uses”,
expr4=“Y is linked to X by a relationship Uses”,
expr5=“Y is an instance of the class “Project”, whose attribute “Location” has as its value the string of characters “Rocquencourt””,
expr6=“D is linked to Z, Z being an instance of the class Person, whose attribute “Name” ends in the character string “Smith””.

The present invention therefore enables the user to create, by simple successive interactive manipulations, complex queries for finding document resources in a database.

In a variant, the user query resulting from the flow diagram described above makes it possible not only to find the identifiers of the target resources but also a certain number of attributes of these resources, such as for example the title and publication date, in order to present to the user a detailed display of the list of resources found. The choice of these presentation attributes is specified in a resource external to the code of the portal application, to make it possible to modify them independently of the portal program.

When the query manager GR receives the user query REQ(n), he submits it, at step 2114 in FIG. 4a, to the SGBD, which returns the list of instances of the class “Documents” satisfying the terms of the query. This list is finally transmitted to the graphics generator GG, at step 2115, which effects a formatting enabling it to be displayed by the browser NW. As with the list of objects shown in FIG. 11, the list of document resources can be formed by titles, which are each the anchor of a hypertext link, passing through which causes the display of the resource itself, by means of the appropriate application chosen according to the format of the resource.

Step 213 of FIG. 3 enables the user to store the current query resulting from the non-cancelled selections, made previously in the interactive session. In the example presented in FIGS. 8 and 9, the user can trigger this operation by pointing to the button in the form of an arrow situated immediately to the right of the title “Bookmarks” in the left-hand box of the browser. When the user activates the command causing the execution of this step, a dialogue box is presented to him asking him to choose a name for this current query. This name will subsequently be used to present this query in the list of bookmarks as it appears in the example embodiments in FIGS. 7, 8 and 9. If the user has previously carried out step 211, the query stored at step 213 is the same as that which was calculated and evaluated at step 211. If the user has not passed through step 211, the current query is calculated according to the same algorithm as that used at step 211. However, the request is not transmitted to the database BDS for evaluation but is stored in the database BDU, with the symbolic name chosen by the user, the date and time of its creation. This query can subsequently be evaluated. It can also be combined with other queries stored in order to form new queries, as is described in FIG. 5. A user having the necessary authorisations can create a bookmark on behalf of a third-party user.

Reference is now made to FIG. 6, which illustrates the implementation of a selection of digital documents by means of predefined bookmarks. A user who has stored queries in the form of bookmarks (step 213 of FIG. 3), either during the current interactive session or during prior sessions, can decide to form new queries by combining some of these stored queries. For this purpose, he can choose a bookmark at step 204, and then a logic operator “AND”/“OR” at step 2042, and finally a second bookmark at step 2043. These successive designations characterise a new query which corresponds to:
a Boolean combination “AND” for the two pre-existing queries chosen, if the operator “AND” has been designated. In this case, the result of the new query is the intersection of the sets which are the results of the two pre-existing queries;
a Boolean combination “OR” for the two pre-existing queries chosen, if the operator “OR” has been designated. In this case, the result of the new query is the combination of the sets which are the results of the two pre-existing queries.

Having thus created a new query, and after having stored it under a symbolic name (bookmark) in the database BDD in accordance with step 213 described above, the user can once again form a new query by combining the one which has just been created with another existing query. The user can thus gradually define queries by intersections or combinations of a chosen number of requests.

The user can evaluate a bookmark stored, at any time in an interactive session. If he has just constructed and named by a bookmark a new query from pre-existing queries (FIG. 4), he can directly request the evaluation of the new query (step 2040); if not he can choose a bookmark at step 204 and then request the evaluation of the query thus designated. In both cases, these operations cause the evaluation of the query stored under the name of the corresponding bookmark in the database BDU.

In the case where the user accesses the evaluation of a query from step 204, two cases may be presented:
if step 204 is the first step performed of the current interactive session, the query is evaluated and the results displayed;
if step 204 is triggered during the interactive session whilst selections have created a current query, a message requests the user to confirm the abandonment of the current query in favour of the query stored under the bookmark. If the user confirms his choice, the current query is abandoned, the session history is deleted and step 204 continues. If the user does not confirm his choice, step 204 is abandoned.

In a variant embodiment, a user can subscribe to a bookmark stored and request to receive the results of the corresponding query by electronic mail, this query being re-evaluated at regular intervals chosen by the user.

The user can at any time perform step 206 by means of which he specifies values of attributes which are to comply with the digital document resources sought. This step is described in detail in FIG. 6. In order to access this step, the user selects the parent class of these resources, presented in the example in FIGS. 7 to 11 under the name “Documents”. FIG. 10 illustrates an example of a graphical interface for specifying the attributes of these resources. The attributes appearing in this graphical interface can differ in each embodiment, since they are defined in the conceptual schema used. This graphical interface is therefore generated dynamically, at step 2060 in FIG. 6, by methods identical to those described at steps 201 and 202, only the structure request here being different. In the embodiment described in the examples, the attributes presented are found in the database BDS by means of the following RQL query:
select * from {:Documents}@P{:$$Y} where $$Y in Literal

At step 2061 in FIG. 6, the result of this query is formatted by the graphics generator GG as indicated at step 202 in FIG. 3, in order to display zones {attribute name, Operator, Value} for all the attributes of the class “Documents”.

At step 2062 in FIG. 6, the user can designate and validate choices of attribute values. A particular entry is then created in the session history at step 2063. This entry comprises as many triplets {Attribute, Operator, Value} as the user has specified constraints on the attributes. If such an entry exists in a session history, it is used at step 211 to restrict the selection of resources sought, without the position of this entry in the history being taken into account in the formation of the query. In other words, the choice of attribute values made at step 206 will have the same semantic whatever the moment in the interactive session at which the user performs step 206.

At the end of this step of updating the history, the user can either directly evaluate the user query (step 211) or choose a new class (step 205).

In addition, the user has the possibility of ending the current interactive session by selecting step 203. In the embodiment proposed as an example, if step 203 is triggered during an interactive session whilst selections have created a current query, and when the last operation performed is not a step 213, a message requests the user whether he wishes to confirm the abandonment of the current query or perform step 213.

The above description is presented in the form of operations like a process. It should be noted, however, that many steps are triggered by the action of the user. Consequently, the sequence of operations as presented is not obligatory in character. It is a case rather of purely descriptive operations, triggered by the action of the operator according to the context presented to him by the display, in accordance with what has been described.

Naturally, the invention is not limited to the embodiment described above by way of example. It can extend to other variants of resource exploration. It can in particular be employed to construct project management applications, for the use of a business or group of businesses. It can also be used for constructing document search and management applications for the use of communities of users on the public web.

Moreover, the invention does not make assumptions on the methods used for creating the objects which are instances of classes, or for describing document resources by means of these objects and specific attributes. It does not introduce any limitations into the types of document resources managed. These may be files in any formats, collections or lists of files or directories, electronic mailboxes, discussion threads, cooperation system whiteboards, etc.

Finally, the invention is perfectly compatible with an organisation of the web in several segments or subsets, each segment being described in a particular BDS database, the application proceeding with the complete or partial replication of the data peculiar to each segment in a centralised server or in many servers themselves distributed. Such an architecture can offer the users the possibility of seeking resources as described, either with regard to a segment, or at the level of the complete web. It is also possible, according to the same principle, to organise the indexing of the web according to a hierarchy of segments with several levels.

In the embodiment used as an example, the choice of the RDF formalism for representing the conceptual schema and all the objects manipulated by the application is guided by the fact that this standard formalism considerably facilitates the exchange of data between many servers, and consequently also facilitates the production of semantic web systems indexed in many cooperating servers.

The present invention also relates to the software code which it involves, particularly when it is made available on any medium which can be read on a computer. The expression “medium which can be read by computer” covers a storage medium, for example magnetic or optical, as well as a transmission means, such as a digital signal or the like.

However, the invention relates only to the method of interrogating this server or servers, and therefore does not tend to constitute a solution to all the difficulties relating to such a hierarchical organisation of the web.

1. Computer system, of the type comprising a query manager (GR) intended to work with a history manager (GH) and a graphics generator (GG) to display entities according to data stored in a database,
characterised in that
the query manager (GR) is capable of reacting to the fact that an entity displayed is pointed to by the user, executing on the database an internal query, defined from a query expression chosen according to the type of the entity, and supplemented according to the entity, which supplies new data, from which the display is modified,
the history manager (GH) is arranged so as to interact step by step with the query manager (GR) in order to construct a user request from successive selections relating to the entities pointed to by the user on the graphical interface, and
the graphics generator (GG) is capable of displaying an adapted representation of the results produced by the query manager, according to a predetermined formatting.

2. Computer system according to claim 1, characterised in that the query manager (GR) comprises a starting query to interrogate the database on its global structure and display all its classes and sub-classes.

3. Computer system according to claim 2, characterised in that the query manager (GR) is able to interrogate entities, of the class or object type, pointed to by the user, on their structures.

4. Computer system according to one of claims 2 and 3, in which the database and the data themselves form class graphs, characterised in that the query manager (GR) is arranged so as to interrogate the class graphs, database and data, in the same way.

5. Computer system according to claim 4, characterised in that the query manager (GR) is capable of executing an internal query in order to display the following elements, in response to an entity pointed to of the class type:
the classes linked, by a predetermined relationship in the base, to the class pointed to,
name-value zones for the attributes of the class pointed to as well as the operators linked to the type of each of the attributes.

6. Computer system according to claim 5, characterised in that the query manager (GR) is capable of executing an internal request in order to display the list of objects which are instances of an entity pointed to, of the class type, once its structure is displayed.

7. Computer system according to claim 6, characterised in that the query manager (GR) is capable of executing an internal query in order to display the following elements, in response to an entity pointed to of the object type:
the documents linked, by a predetermined relationship in the base, to the object pointed to,
all the attributes of the object pointed to.

8. Computer system according to one of claims 3 and 5, characterised in that the history manager (GH) comprises a means of storing the structure elements of each entity pointed to of the class type, as well as values of any attributes chosen by the user for this class.

9. Computer system according to claim 8, characterised in that the history manager (GH) is able to successively combine elementary queries constructed from the stored elements, according to a logic operator, to calculate the user query.

10. Computer system according to claim 9 taken in combination with claim 8, characterised in that the logic operator is determined according to the elements stored.

11. Computer system according to claim 9, characterised in that the history manager (GH) is arranged so as to transmit the calculated user query to the query manager for evaluation.

12. Computer system according to claim 1, characterised in that the query manager (GR) comprises a means of storing user queries under a symbolic name in a list of predefined queries.

13. Computer system according to claim 12, characterised in that the history manager (GH) is able to construct a user query from two previously stored queries, combining them by means of a chosen logic operator.

14. Computer system according to claim 5, characterised in that the query manager (GR) is capable of executing an internal request in order to display “name-value-operator” zones for the document attribute, in response to a pointing to the document class.

15. Method for generating a web portal graphical interface, intended to interrogate a database,
characterised in that it comprises the following steps:
a. presenting to the user a starting display derived from stored data, the displayed entities being of the class or object type,
b. in response to the pointing by the user to an entity, executing an internal query on the database, defined from a query expression chosen according to the type of entity, and supplemented according to the entity,
c. modifying the display from data supplied by step b,
d. repeating steps b and c until there is a decision by the user.

16. Method according to claim 15, characterised in that step a comprises an initial display of all the classes and sub-classes in the database.

17. Method according to one of claims 15 and 16, characterised in that step b comprises a step of displaying the following elements, in response to a pointed to entity of the class type:
the classes linked, by a predetermined relationship in the base, to the class pointed to,
name-value zones for the attributes of the class pointed to as well as the operators linked to the type of each of the attributes.

18. Method according to claim 17 taken in combination with one of claims 15 and 16, characterised in that steps a and b comprise a step of interrogating the class graph, this interrogation being applied to the database at step a, and to the data themselves at step b.

19. Method according to claim 15, characterised in that step c comprises a prior storage of the elements issuing from step b.

20. Method according to claim 19, characterised in that it also comprises a step of successive combination of elementary user queries, each issuing from the stored elements, according to a predetermined logic operator for calculating the user query.
